(19) United States
(12) Patent Application Publication
(10) Pub. No.: US 2007/0118438 A1
(43) Pub. Date: May 24, 2007

(54) Interactive Menu Application

(76) Inventors: Joshua Boylan Long, Tempe, AZ (US); Michelle G. Kennedy, Tempe, AZ (US); Shahram Bahadori, Tempe, AZ (US)

Correspondence Address: LAW OFFICE OF WAYNE CARROLL, 7830 N. 23RD AVE, PHOENIX, AZ, 85021, US

(21) Appl. No.: 11/561,604

(22) Filed: Nov. 20, 2006

Related U.S. Application Data
(60) Provisional application No. 60/738,321, filed on Nov. 18, 2005.

(51) Int. Cl. G06Q 30/00

(52) U.S. Cl. 705/26

(57) ABSTRACT

A system including the steps of: storing an electronic image, where the electronic image includes a portion related to an offer; associating the portion with a price; sending the electronic image over a wide-area network; displaying the electronic image upon a network-capable device, where the device is structured and arranged to communicate over the wide-area network; accepting selection of the portion as an electronic order; and confirming the electronic order by displaying the portion and the price.

### CROSS REFERENCE TO RELATED APPLICATIONS

This application claims priority to, and incorporates by reference, provisional application US 60/738,321. This application claims priority to, and incorporates by reference, provisional application filed Nov. 17^{th} 2006 titled: SYSTEM AND METHOD FOR PLACING AN ORDER USING AN ENHANCED DIGITAL IMAGE; for applicant: Joshua Boylan Long, et al. Attorney Docket# 5005-4, Express Mail label number EQ 103099642 US.

### REFERENCE TO COMPUTER PROGRAM LISTING APPENDIX

This application includes and is supported by information in four appendices with the necessary files to implement and use the present invention. Appendix A is contained in a file: db_schema.txt which describes an example database for use with the present invention. Appendix B is contained in a file: html.txt which contains html computer code for use in an example embodiment of the invention. Appendix C is contained in a file: java.txt which contains java computer code for use in an example embodiment of the invention. Appendix D is contained in a file js.txt which contains java script code for use in an example embodiment of the invention.

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to computer software.

2. Description of the Prior Art

Web sites are request/response in nature. Server-side state, be it on a database or in RAM, or whatever, can only be made to be in sync with the state of the client (the response, typically WML or HTML) through a request to the server. Each request gives the server a chance to figure out what has changed since data was last recorded. This process makes for web applications that seem latent compared to desktop applications. A technology called AJAX (Asynchronous JavaScript Over XML), first debuted in Internet Explorer and then later supported in some way or another by competing browsers, has become common-place enough to warrant exploitation on visible, accessible sites like Google Maps, Google's Email Application, A9.com's applications, Flickr, and any number of other cutting edge applications on the web featuring incredibly intelligent, dynamic interaction models.

### BRIEF SUMMARY OF THE INVENTION

The invention is a system which uses an image file on a computer, through an interactive website, to select one of many pre-defined portions of the image which are items available for purchase. The system is superior to prior systems commonly used on e-commerce websites because the interface for adding items for purchase is very simple. For example, a restaurant owner can easily use the system to make a digital version of a menu. The owner scans a restaurant menu and then selects areas of the menu which each indicate each item for purchase on the menu. The owner enters a price associated with each selected area, and then the menu is ready for customers viewing a web page. When the customer views a web page for the restaurant, they see an image of the menu, and each item on the menu is highlighted when the customer scrolls over the item with a pointing device. To order an item the customer simply clicks on the highlighted menu item, and a copy of the image which is within the area selected by the restaurant owner is added to the customers order. The completed order will consist of one or more parts of the original image. When the customer places the order each item, as a copy of a piece of the original image, is sent to the restaurant, by fax or some other way.

The interactive menu system leverages AJAX technology, to facilitate the menu selection screen. Behind the scenes, on the server, is Tapestry, which has featured robust support for Ajax. In particular, the system uses a set of components called Tacos, which facilitates turning a regular Tapestry page into an Ajax-enabled page. This removes a lot of the work that had to be done in hand-written applications like Gmail, Google Maps, et. al. Leveraging this support makes it relatively easy to convert a data-oriented application which typically requires many requests into an application that keeps in sync with the server without the latency of a full page refresh.

Among the objects of the present invention are the following:

To provide a website interface to input prices which is easy to use for those who have little or no programming skills.

To provide a website interface which is efficient and quick without the latency experienced when a page must be refreshed.

To provide a website interface where an image is cropped without the need for a separate image editor program.

To provide an interactive version of an image on a website interface.

To provide a simple method for small business owners to publish an interactive version of current menus and pricing.

### BRIEF DESCRIPTION OF THE DRAWINGS

FIG. 1 is a flow chart of how a customer may navigate a website which employs the present invention, to select a restaurant.

FIG. 2 is a flow chart of how a customer may navigate a website which employs the present invention, to select place an order or make a reservation.

FIG. 3 is a flow chart of how a restaurant owner, may input a menu and pricing for use on a website which employs the present invention.

FIG. 4 is an example of a website for a customer to use to order from a menu using the present invention.

### DETAILED DESCRIPTION OF THE INVENTION

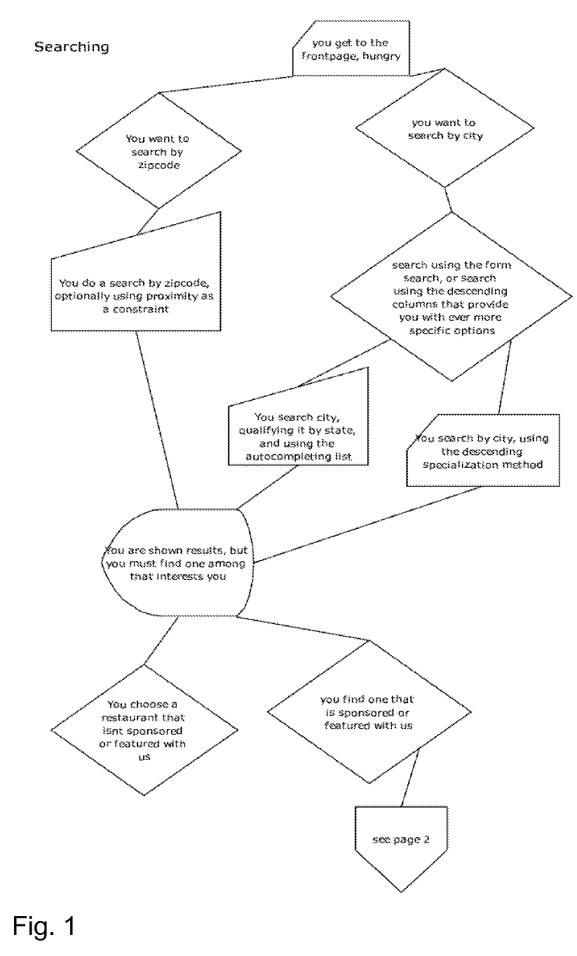

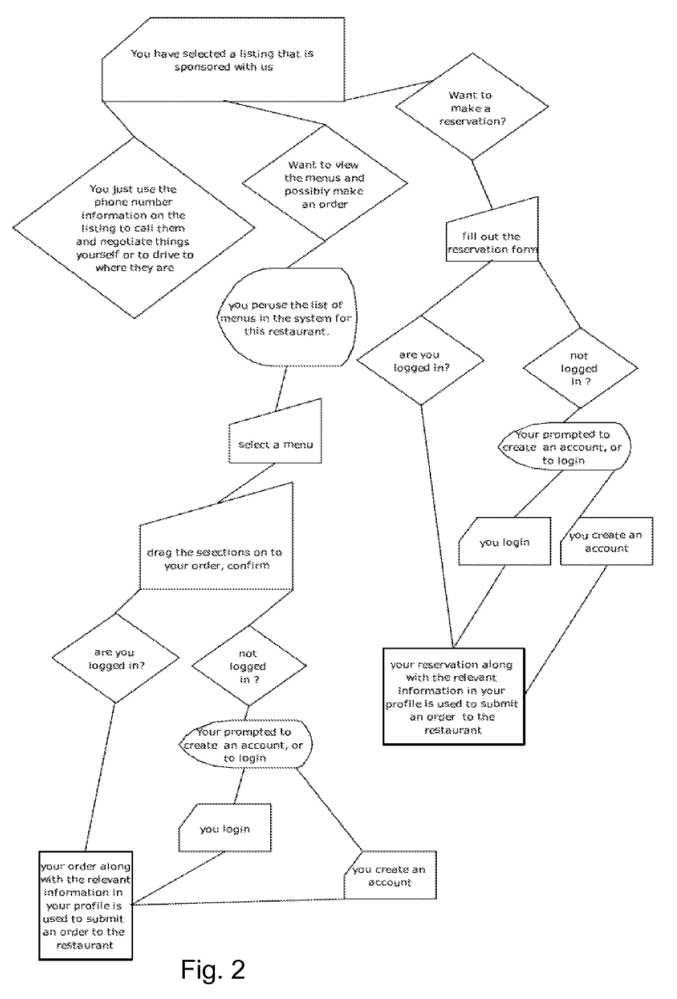

FIG. 1 is flowchart showing how a customer may come to a website using the present invention to select a restaurant. According to the preferred embodiment of the invention, a website will have multiple listings of businesses, such as restaurants. The business may be searched by city, state or other geographic designation, or by postal ZIP code. In the preferred embodiment, the listing of businesses includes businesses which have a personalized page on the site, and businesses which do not have a personalized page on the site. When a business, such as a restaurant is selected which has a personalized site more options are available as shown on FIG. 2

FIG. 2 shows options which may be available to a customer using a website employing the present invention, after selecting a business which has a personalized page on the website. When a reservation is made, or when an order is placed, the customer will be asked to log in with a personalized account. Information from the personalized customer account, with the order or reservation information is then sent to the restaurant. The information can be sent to the restaurant electronically, by fax, phone or any other reliable method of communication.

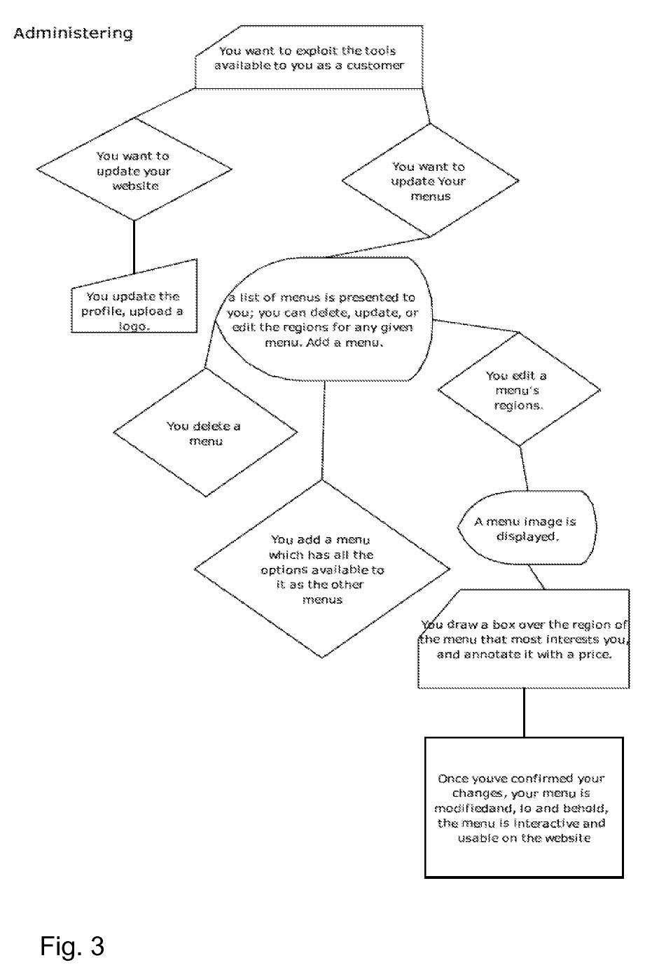

FIG. 3 shows a flowchart of how a businesses owner, such as a restaurant owner, may enter and update information on a personalized page of the website using the present invention. The restaurant owner may upload a menu as an image. The restaurant owner may also fax, or send a hardcopy of the menu which will be converted into a digital image at another location, and uploaded to the webpage. The image is then enhanced by the owner, who uses the software running on the website to select regions of the image, each region representing a separate item on the menu. When a region is selected the software on the website displays an input form for the owner to input the price of the menu item. The owner may continue selecting regions of the image, until all items for sale on the image have been selected, and prices entered for each item. The owner may be given the opportunity to confirm changes to the personalized portion of the website. After a confirmation the personalized portion of the website is available for use by the purchasing public. This is done without the restaurant owner hosting a website, without any software tools other than a standard web browser. It is also accomplished quickly and easily, so that a restaurant may update a menu daily, or more often if desired.

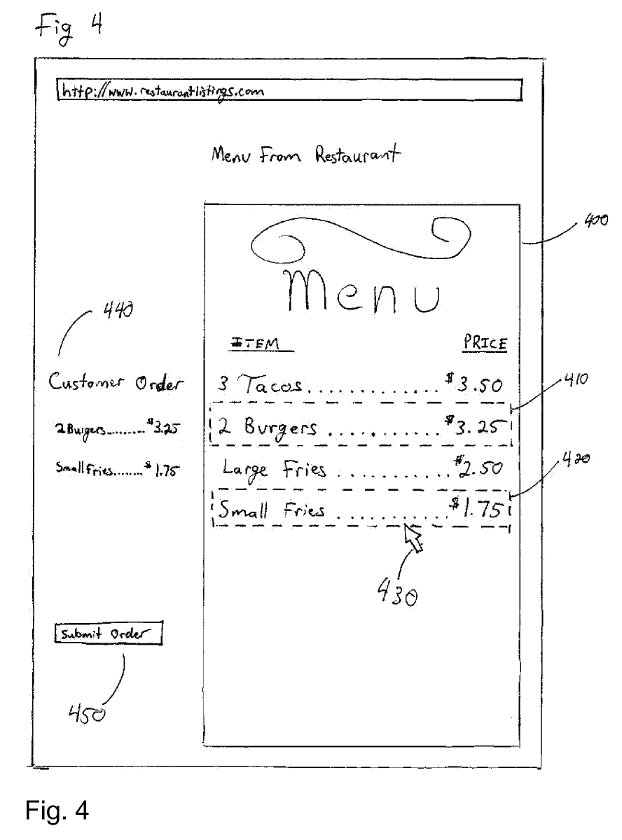

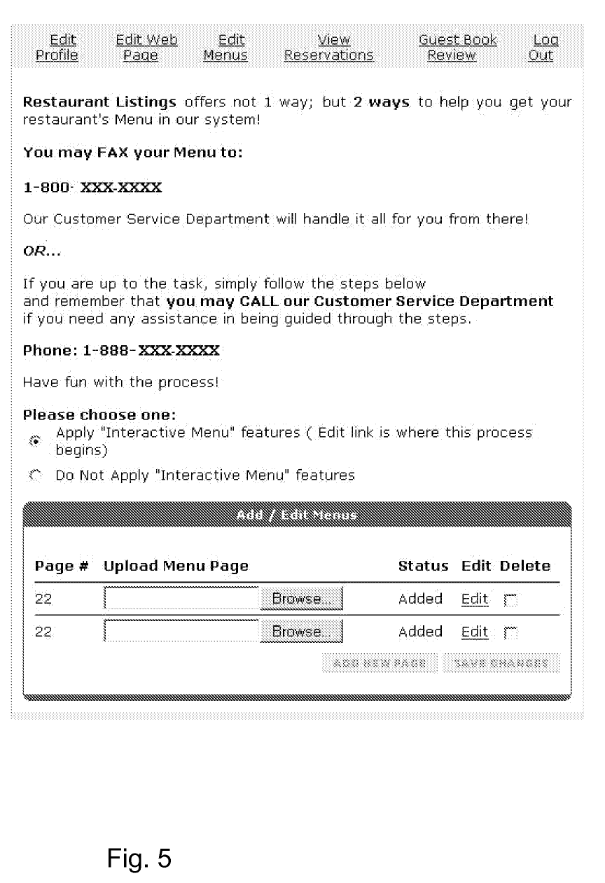

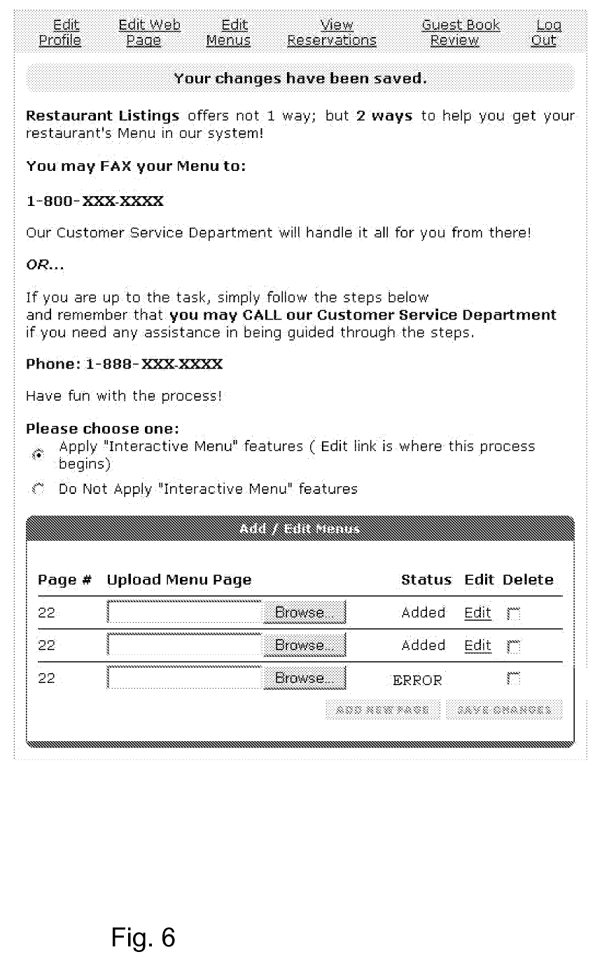

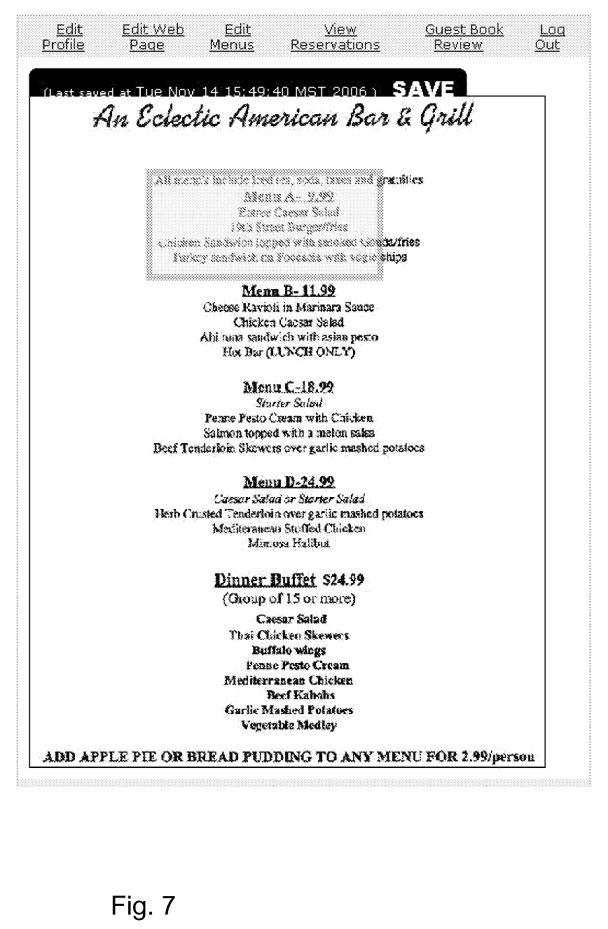

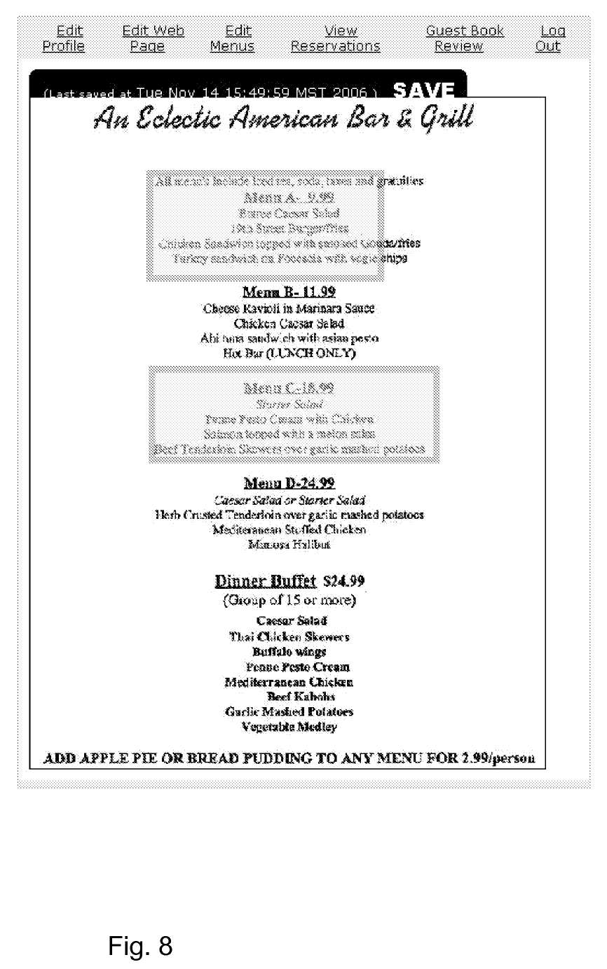

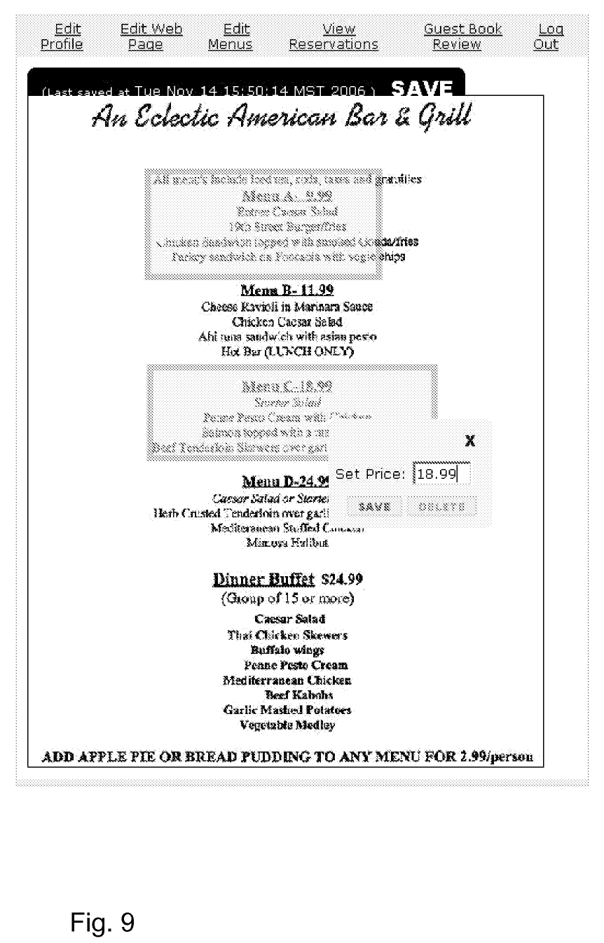

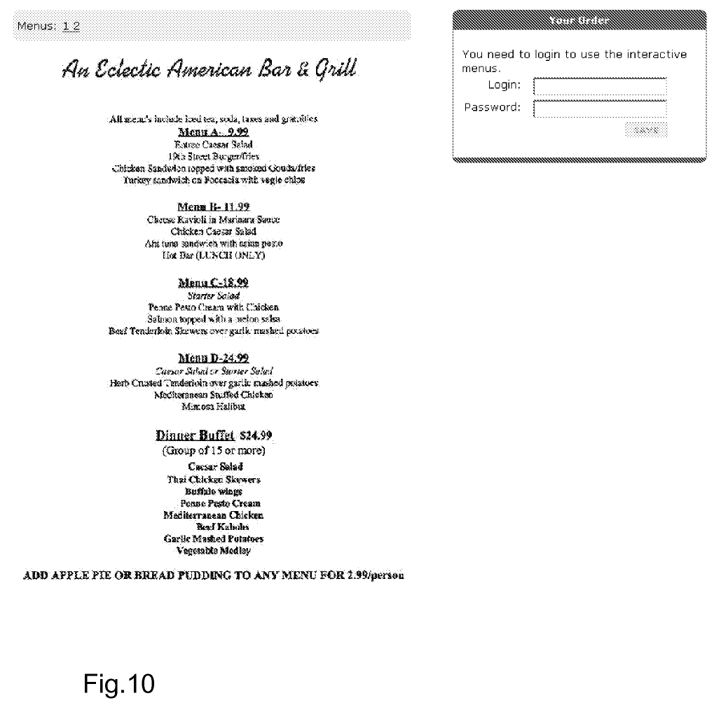

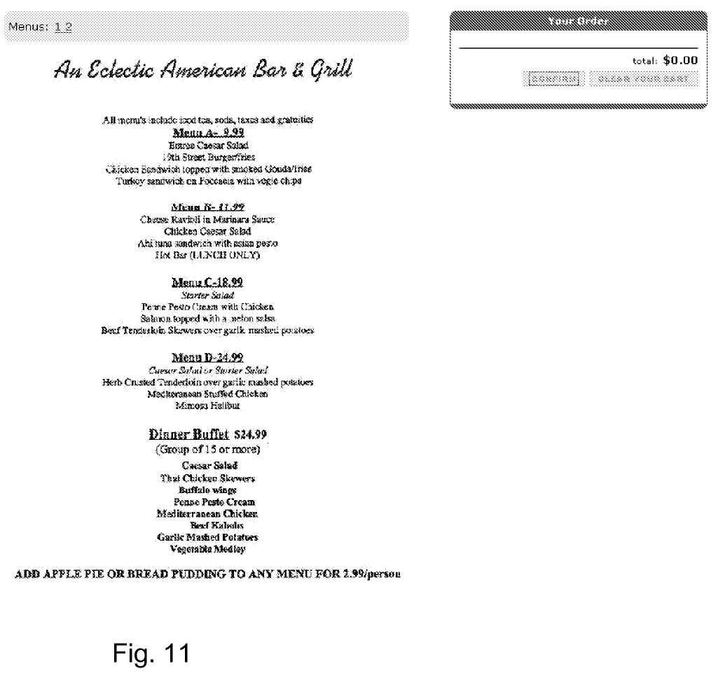

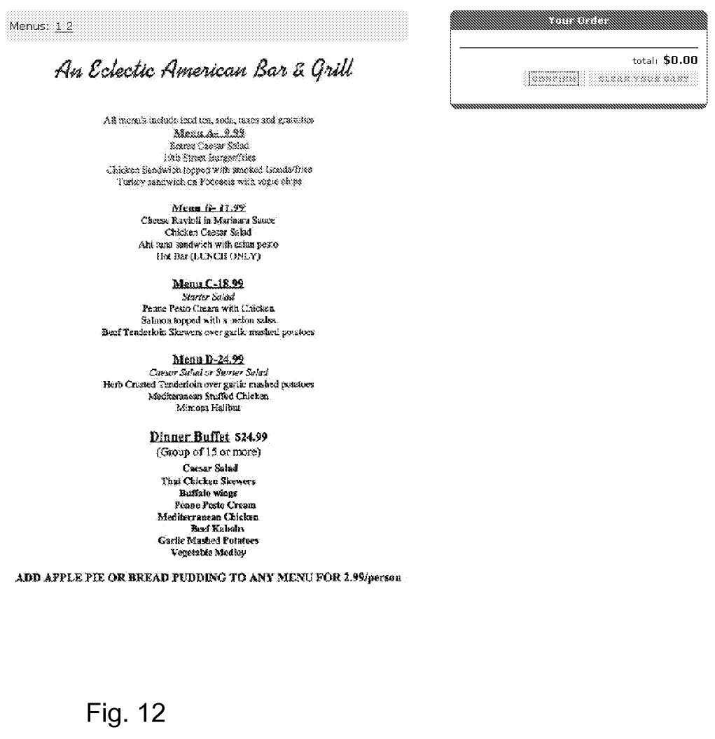

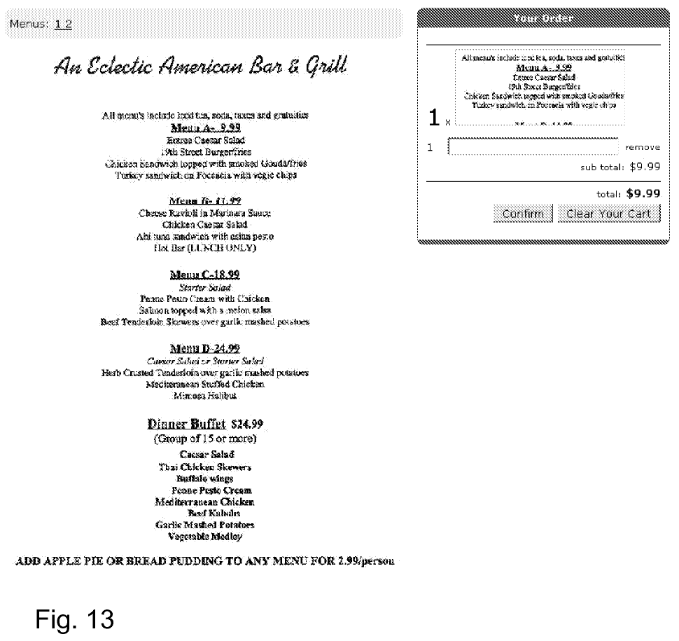

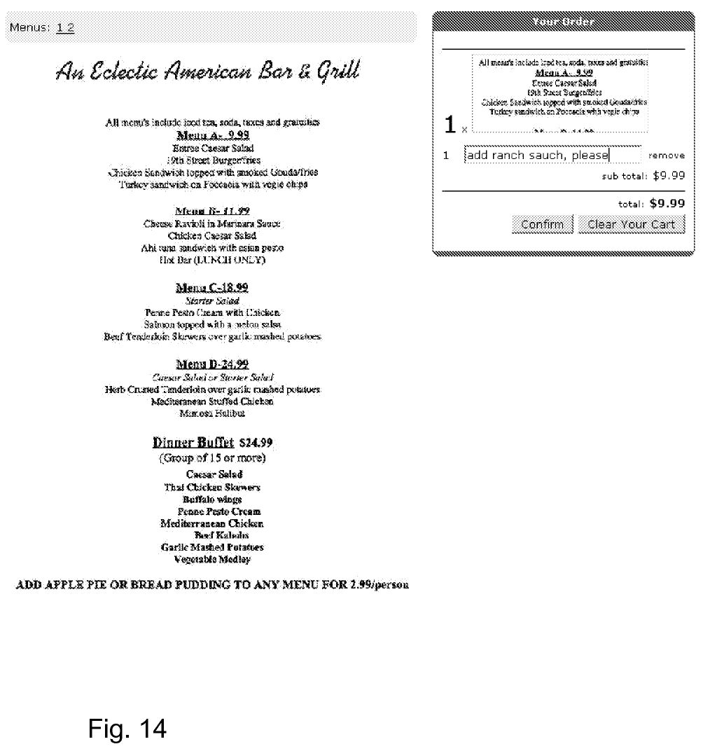

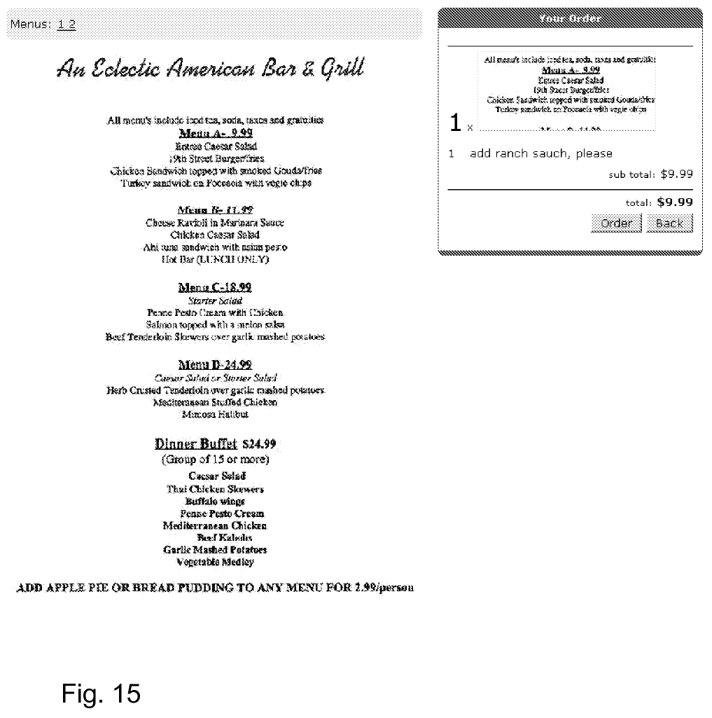

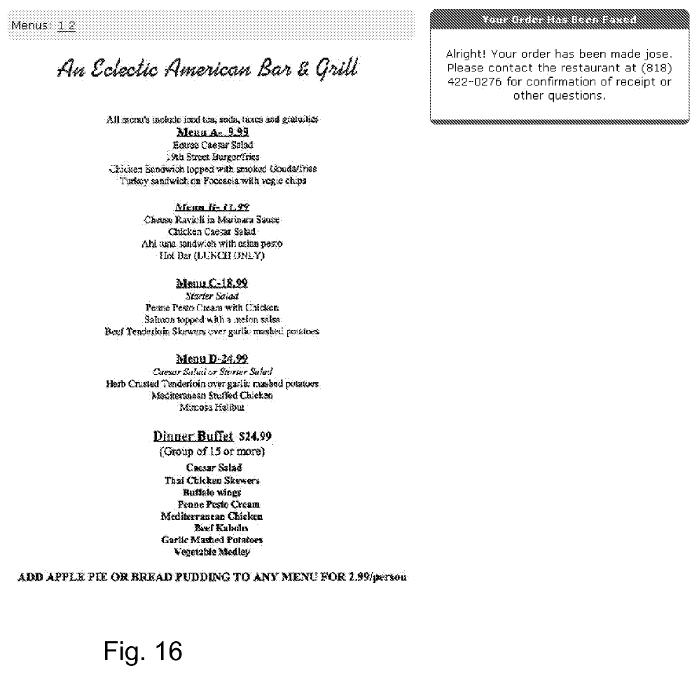

Referring to FIG. 4, an example of a personalized page of a website employing the present invention is shown. According to the preferred embodiment of the invention, a customer may order from an enhanced image of a menu, 400. The enhanced image of a menu, 400 has regions defined, for example a first region, 410, around the words “2 Burgers . . . $3.25” and a second region, 420, around the words “Small Fries . . . $1.75”. The regions, 410, and 420, as well as other regions on the enhanced image of a menu, 400, were selected by the restaurant owner. When the customer scrolls over a region, using a pointing device, 430, then the defined region may be highlighted. The customer may either “drag and drop” the selected region, or “double click” the selected region to add it to the Customer order section, 440. When an item from the menu is added to the Customer Order section, 440, then an cropped image, which is the defined region, 410, or 420, is placed in the section of the customers order. The customer order section may also contain pricing totals, and quantity of each item ordered.

After the customer is satisfied with the order placed, the order may be confirmed by clicking on the “Submit Order” button, 450, or by any other means which will confirm an order. When the order is confirmed, an order is produced which contains information about which customer has placed the order, and the cropped images from the enhanced image of the menu, 410 and 420, corresponding to the items which were ordered.

Referring again to FIG. 4, when a customer selects an item from the menu, 400, and the cropped image then appears in the Customer Order section, 440, a full page refresh is not necessary using the present invention. Instead the server communicates with the web browser application on the computer that the customer is using. This interface provides a much faster response for the customer, and may respond as if the entire application was on the customer's computer.

The computer code appendices: A, B, C, and D. are incorporated by reference into the detailed description section of this specification.

What is claimed is:

1. A system comprising the steps of:
storing an electronic image;
wherein the electronic image comprises a portion related to an offer;
associating the portion with a price;
sending the electronic image over a wide-area network;
displaying the electronic image upon a network-capable device;
wherein the device is structured and arranged to communicate over the wide-area network;
accepting selection of the portion as an electronic order; and
confirming the electronic order by displaying the portion and the price.

2. A system comprising the steps of:
receiving an electronic image;
storing the electronic image in a database;
displaying, on a computing device, a structured document comprising the electronic image;
embedding web-browser-executable software within the structured document,
allowing execution of the web-browser-executable software wherein the web-browser-executable software performs the steps of,
allowing selection of a portion of the electronic image, whereby the computing device receives a selection;
updating the displaying of the structured document to indicate the portion;
transmitting the selection to the database;
allowing inputting of a price; and
storing, in the database, a relationship between the price, the portion and the electronic image.
